(19) United States
(12) Patent Application Publication
(10) Pub. No.: US 2026/0179004 A1
(43) Pub. Date: Jun. 25, 2026

(54) DYNAMIC RESOURCE ALLOCATION VERIFICATION

(71) Applicant: MOTOROLA SOLUTIONS, INC., Chicago, IL (US)

(72) Inventors: Mariya BONDAREVA, Loxahatchee, FL (US); Yanlin HAN, Naperville, IL (US); Volodymyr RYBALKIN, Logan, UT (US); Jonathan Wai Choong CHAN, Bukit Mertajam (MY); Roger D. DONALDSON, Vancouver (CA)

(21) Appl. No.: 18/989,908

(22) Filed: Dec. 20, 2024

(51) Int. Cl. G06Q 10/0631; G06Q 50/26; G10L 17/00; H04M 3/22

(52) U.S. Cl. CPC G06Q 10/06312; G06Q 50/26; G10L 17/00; H04M 3/2281

(57) ABSTRACT

A method for dynamically verifying the allocation of the agency units is described. The method comprises retrieving a first dataset comprising information identifying active public safety incidents. A second dataset comprising information identifying agency units assigned by dispatchers to the active public safety incidents is also retrieved. Mobile radio communication between the dispatchers and agency units dispatched by the dispatchers is monitored. The content of the mobile radio communication is analysed in real-time, using a machine learning model, to confirm which of the agency units are available and which are assigned to the active public safety incidents. Error correction procedures Are executed when it is determined that the agency units are incorrectly identified as at least one of assigned and available. A device comprising a processor and a computer-readable storage medium storing program instructions that, when executed by the processor, causes the processor to perform the method is also described.

The present specification related generally to allocating emergency response units to active public safety incidents and specifically to a system and method for dynamically verifying the allocation of the agency units.

### BACKGROUND

Public safety agencies (for example, police stations, fire stations, dispatch centers, and the like) may receive information from various sources regarding potential public safety incidents. For example, public safety agencies may receive information regarding potential public safety incidents via an emergency communication channel (for example, 9-1-1), a non-emergency communication channel (for example, 3-1-1), a tip line communication channel, and the like. In response to received information regarding a potential public safety incident, a public safety dispatcher may instruct one or more agency units to respond to the public safety incident.

Computer-aided dispatch (CAD) systems are utilized by the public safety agencies to prioritize and record incident calls, identify the status and location of agency units in the field, and effectively dispatch agency units. However, state-of-the-art CAD systems cannot validate the information about the agency units. As a result of this technical deficiency, precious time may be lost getting the agency units to respond to the public safety incident.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system for dynamic resource allocation verification.

FIG. 2 is a block diagram showing a device structure of a resource management system.

FIG. 3 is a flowchart illustrating operation of the resource management system.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Land Mobile Radio (LMR) communication is an important aspect of Computer Aided Dispatch (CAD) for emergency service dispatchers (also referred to simply as dispatchers). However, to effectively use the CAD, the dispatchers should know the allocation of the resources. That is, which agency units are free and which agency units are assigned to active public safety incidents (also referred to simply as active incidents).

The dispatchers can use indications received over one or more LMR channels to identify which agency units are assigned to the active incidents. For example, an agency unit may report that they need additional resources for an active incident over the LMR channel. This implies that the reporting agency unit is presently occupied. Examples of agency units include first responders such as law enforcement, emergency medical services (EMS), firefighters, and the like.

Conversely, the dispatchers may receive indications from the agency units that they are available. For example, an agency unit may report over the LMR channel that they have completed their assignment. The dispatchers can use this information to update the availability status of the agency units. However, this is a difficult task to achieve because there can be 50 or more different units working on 10 different active incidents on the same LMR channel or on several shared LMR channels. Thus, mistakes can be made which are not readily detectable and may result in an unnecessary delay deploying the agency units.

Further, a system and method for quality control after the assignment of the agency units is also desired. Consider, for example, an active incident that requires the deployment of both law enforcement and EMS agency units. The EMS agency unit proceeds directly to the active incident, but the law enforcement agency unit is delayed due to a misunderstanding of the assignment. As a result, the EMS agency unit needs to wait until the law enforcement agency unit is eventually corrected and arrives on scene. In such circumstances, precious time is lost that can be crucial to resolving the active incident.

In accordance with an aspect of the present specification, there is provided a method including: retrieving a first dataset including information identifying active public safety incidents; retrieving a second dataset including information identifying agency units assigned by dispatchers to the active public safety incidents; monitoring mobile radio communication between the dispatchers and agency units dispatched by the dispatchers; analysing, using a machine learning model, content of the mobile radio communication in real-time to confirm which of the agency units are available and which are assigned to the active public safety incidents; and executing error correction procedures when it is determined that the agency units are incorrectly identified as at least one of assigned and available.

In some embodiments the content of the mobile radio communication may be analyzed in real-time to confirm that the dispatched agency unit matches the assigned agency unit. Error correction procedures when the dispatched agency unit does not match the assigned agency unit. The dispatched agency unit may be continued to be monitored to validate that the agency unit is progressing toward to the assigned public safety incident when the dispatched agency unit matches the assigned agency unit. Error correction procedures may be executed when it is determined that the dispatched agency unit diverts from the assigned public safety incident.

In some embodiments, the assigned agency unit may automatically be removed from the public safety incident. The public safety incident may be re-assigned to one of the unassigned agency units as part of the error correction procedures.

In some embodiments, instructions may be presented on a graphical user interface of the dispatcher to instruct the dispatcher with steps to implement the error correction procedures.

In some embodiments, at least one of a voice signature, background noise, and speech structure in the mobile radio communication may be analyzed to determine an identity of the dispatched agency unit.

In some embodiments, a location of the agency units may be monitored in real-time. The location of the agency units may be used to validate the analysed content from the mobile radio communication.

In some embodiments, inter-unit mobile radio communication between different ones of the agency units may be monitored by the machine learning model, and the content of the inter-unit mobile radio communication may be used to validate that the agency unit is progressing towards the assigned public safety incident. Error correction procedures may be executed when the dispatched agency unit diverts from the assigned public safety incident.

In some embodiments, the error correction procedures may further include transmitting an alert to the dispatcher and the dispatched agency unit outside of the mobile radio communication to validate the determination that the agency units are incorrectly identified as at least one of assigned and available.

In some embodiments, the public safety incidents are analyzed to identify incidents proximal to each other to which multiple agency units have been assigned. Information about the incidents proximal to the public safety incident to which they have been assigned may be communicated to each of the multiple agency units. Arrival of the multiple agency units to the proximal incidents may be sequenced.

Each of the above-mentioned embodiments will be discussed in more detail below, starting with example system and device architectures of the system in which the embodiments may be practiced, followed by an illustration of processing blocks for achieving an improved technical method, device, and system for situational media integration.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

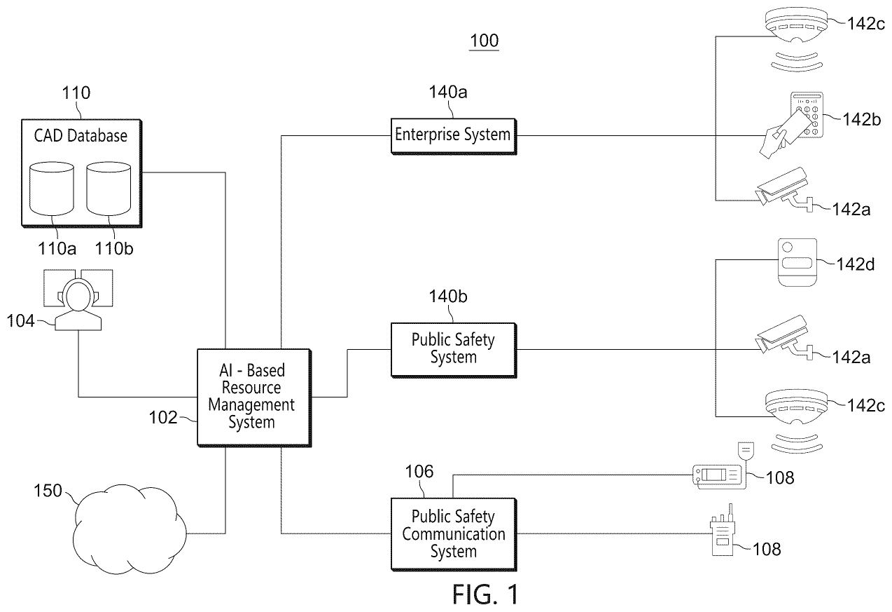

Referring to FIG. 1, an example system for dynamic resource allocation verification is illustrated generally by numeral 100. The system 100 includes a resource management system 102, a dispatch system 104, a public safety communication system 106, a radio 108, and a computer aided dispatch (CAD) database 110. The system 100 may also be coupled with external surveillance systems 140. The system may further be coupled with a mobile network. 150.

In some embodiments, the CAD database 110 includes a first dataset 110a and a second dataset 110b. The first dataset 110a stores real-time data relating to active incidents and historical data relating to resolved incidents. The first dataset 110a includes the time of a call reporting the incident, a location of the incident, a type of incident, and any additional notes provided by dispatchers or first responders (agency units). This data enables quick access to information during active incidents and supports after-action reviews.

The second dataset 110b stores information identifying agency units assigned by dispatchers to the active public safety incidents. Thus, the second dataset 110b tracks the status and availability of the agency units, keeping records of which of the agency units are currently active and which are available. The CAD database 110 provides geolocation data to facilitate optimal dispatch decisions based on proximity and response time.

The dispatch system 104 is used by a dispatcher to communicate with the agency units via the public safety communications system 106. Specifically, the public safety communications system 106 provides the infrastructure for LMR communication between the dispatcher and the agency units, as described below. The dispatch system 104 includes a graphical user interface onto which an interactive dispatch dashboard is displayed. The dashboard presents information to the dispatcher from the CAD database 110 and the resource management system 102. The dashboard also allows the user to enter the identities of the agency units assigned to active incidents.

In some embodiments, the public safety communication system 106 includes fixed network equipment (FNE) for radio communication. The FNE may include a trunked radio system, operable to assign frequency channels. The FNE may include any transmission system operable to receive, relay, and transmit electronic signals. The radio 108 can transmit a talk group call to the FNE via a channel. The radio 108 may transmit the talk group call, using a variety of applications. For example, the radio 108 may transmit the talk group call based on a push to talk (PTT) application. The PTT application may be activated when a user employs an interface, such as pressing and holding a button. In some embodiments, the radio device 108 can be an APX™ radio by Motorola Solutions, Inc.

The surveillance systems 140 may include private enterprise systems 140a, public safety systems 140b, and the like. The surveillance systems 140 may be coupled with surveillance devices such as closed-circuit television (CCTV) cameras 142a, door/building access devices 142b, halo sensors 142c, body worn cameras 142d, and the like.

In some embodiments, the mobile network 150 includes wireless broadband technologies to facilitate communication over wireless wide area networks (WWANs) and/or wireless local area networks (WLANs). WWANs use mobile communication technologies like 3G, 4G LTE, 5G, 6G and the like to connect devices to a network, such as the Internet. WLANs use radio waves to connect the devices to the network. At present this is typically done using the IEEE 802.11 Wi-Fi standards. The mobile network 150 facilitates communication between the resource management system 102 and the agency units outside of the public safety communication system 106. For example, the resource management system 102 can communicate with the agency units using a smart phone or other Internet connected device rather than the radio 108.

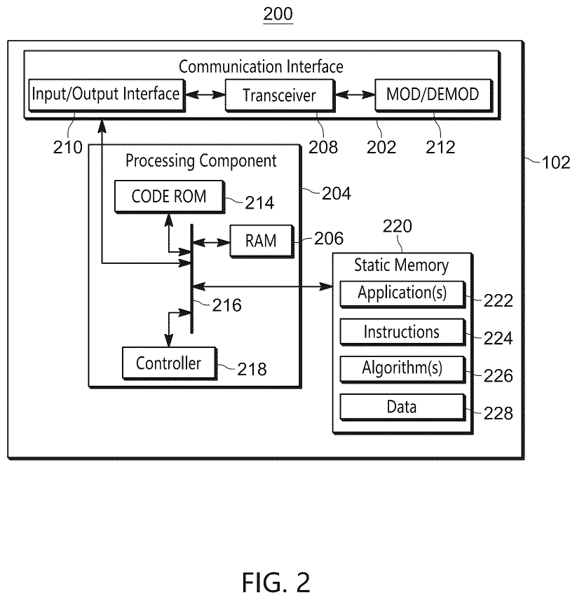

Referring to FIG. 2, a schematic block diagram of an example of the resource management system 102 is illustrated generally by numeral 200. The resource management system 102 may include a communication interface 202, a processing component 204, and a memory 220.

The communication interface 202 includes one or more transceivers 208, input/output (I/O) interfaces 210, and modems 212. The I/O interfaces 210 may include one or more wired and/or wireless interfaces that are configurable to communicate with suitable components of the system 100. For example, the I/O interfaces 210 may interface with the dispatch system 104, the public safety communication system 106, the CAD database 110, and the external surveillance systems 140.

The one or more transceivers 208 may be adapted for communication with the mobile network 106. In addition to, or instead of, the I/O interfaces 210, the mobile network may be used to communicate interface with the dispatch system 104, the public safety communication system 106, the CAD database 110, and the external surveillance systems 140. For example, the one or more transceivers 208 may be adapted for communication with one or more of the Internet, a Bluetooth network, a Wi-Fi network, for example operating in accordance with the IEEE 802.11 standards, an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to the modem 212.

The processing component 204 may include a Read Only Memory (ROM) 214, a Random Access Memory (RAM) 206, a common data and address bus 216 and a controller 218. The ROM 214, the RAM 206, and the controller 218 are communicatively coupled to the common data and address bus 216. Further, the communication interface 202 and the memory 220 are communicatively coupled to the processing component 204 via the common data and address bus 216.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device.

The memory 220 provides a non-transitory computer readable medium for storing machine readable instructions to implement one or more programs or applications 222, instructions or program code 224, algorithms 226, and/or application data 228. While the instruction or program code, 224, algorithms 226, and the application data 228 are shown as being separate from the applications 222, they may be components of the applications 222.

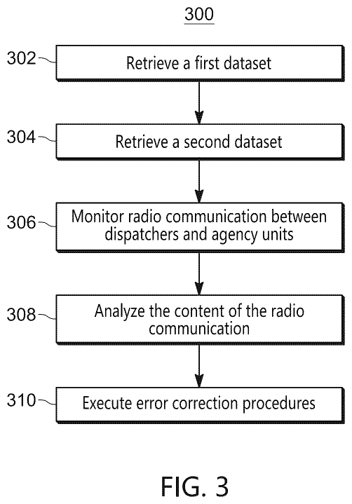

Thus, for example, the memory 220 stores instructions and/or program code 224 and/or algorithms 226 and/or data 228 corresponding to the at least one application 222 that, when executed by the controller 218, enables the controller 218 to implement functionality for real-time situational media integration, including but not limited to, the blocks of the method set forth in FIG. 3.

Put another way, the memory 220 may comprise a non-transitory computer-readable storage medium having stored thereon program instructions that, when executed by the controller 218, cause the controller 218 to perform a set of operations comprising the blocks of the method set forth in FIG. 3.

The application and/or one or more of the algorithms 222 may include programmatic algorithms, and the like, to implement functionality as described herein.

Alternatively, and/or in addition to programmatic algorithms, the application and/or the one or more of the algorithms may include one or more machine learning algorithms to implement functionality as described herein.

The one or more machine learning algorithms of the application and/or the algorithms may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

Furthermore, in examples where the application and/or the one or more of the algorithms includes one or more machine learning algorithms, the application and/or the one or more of the algorithms may be operated in a training mode to train the application and/or the one or more of the algorithms to implement the functionality described herein.

Referring to FIG. 3, a flowchart representative of a method for dynamic resource allocation verification is illustrated. The operation of the method corresponds to machine readable instructions that are executed by the controller 218. In the illustrated examples, the instructions represented by the blocks are stored at the memory 220 for example, as the application 222 and/or the algorithms 226. The methods are some ways in which the controller 218 and/or the resource management system 102, and/or the system 100 may be configured. Furthermore, the following discussion of the methods will lead to a further understanding of the system 100 and its various components.

The methods need not be performed in the exact sequence as shown and likewise various blocks may be performed in parallel rather than in sequence. Accordingly, the elements of the methods are referred to herein as “blocks” rather than “steps”. The methods may be implemented on variations of the system 100 of FIG. 1, as well.

Furthermore, in the description of the methods, reference is made to at least one computing device performing the method as functionality indicated by the method may be performed in a distributed manner.

Referring to FIG. 3, a flowchart representative of a general method for dynamic resource allocation verification is illustrated generally by numeral 300. At block 302 the resource management system 102 retrieves the first dataset 110a from the CAD 110. The first dataset 110a includes information identifying active public safety incidents. At block 304, the resource management system 102 retrieves the second dataset 110b from the CAD 110. The second dataset 110b includes information identifying agency units assigned by dispatchers to the active public safety incidents.

At block 306, the resource management system 102 monitors mobile radio communication between the dispatchers and agency units dispatched by the dispatchers. In some embodiments, the resource management system 102 also monitors inter-unit mobile radio communication between different ones of the agency units. In some embodiments, the resource management system 102 uses artificial intelligence to monitor the LMR communication between the dispatch system 104 and the public safety communication system 106 to identify participating agency units. For example, the agency units can be identified based on audio and speech structure in the communication. The audio includes a voice signature of the agency unit. The voice signature includes reflections of cadence, accent, speech disfluency (such as stuttering), intonations, and the like. The audio also includes background noise. The speech structure includes grammar, lexicon, and filler words. The audio and speech structure in the communication can be used to uniquely identify the agency units.

At block 308, the resource management system 102 analyses content of the mobile radio communication in real-time to confirm which of the agency units are available and which are assigned to the active public safety incidents. For example, the resource management system 102 uses a dispatcher utterances context and an agency unit utterances context to identify the availability status of the agency units. That is, the availability status of the agency unit identifies whether the agency unit is assigned to an active incident or if the agency unit is available.

There may be many reasons why an agency unit might be identified as available when they are actually assigned to an incident and vice versa. For example, there may be noise at the location of an agency unit during the dispatch. The noise may result in the dispatcher hearing the incorrect unit number of the agency unit. As another example, a mistake can be made because of the input tool that the dispatcher uses to input the unit number of the agency unit. A common input tool is a mouse. On the dashboard of the dispatch system 104, the dispatcher is presented with a call list, listing the ongoing events, and an agency unit list, listing available agency units. Both lists change as the ongoing events are opened/closed, or the agency units are cleared or are dispatched. Accordingly, as the lists change, the dispatcher may accidentally assign the wrong agency unit to the ongoing event without realizing it. Thus, the dispatcher may communicate correct information over the radio while sending the agency unit to the wrong incident.

If the resource management system 102 is certain of the availability status of the agency units, the resource management system 102 notifies the dispatcher and the agency unit accordingly. In some embodiments, the resource management system 102 is certain of the availability status if the confidence score is above a predefined threshold. The dispatcher and the agency unit are notified outside of the LMR channel. For example, the agency unit may be notified on a smart phone, vehicle unit, or other portable computing device. The dispatcher may be notified on a smart phone, on a dashboard of the dispatch system 104, or other computing device.

If the resource management system 102 is uncertain of the availability status of the agency units, the resource management system 102 requests confirmation from one or both the dispatcher and the agency unit. In some embodiments, the resource management system 102 is uncertain of the availability status if the confidence score is below a predefined threshold. The dispatcher and the agency unit are contacted outside of the LMR channel. For example, the agency unit may be notified on a smart phone, vehicle unit, or other portable computing device. The notification requests that the agency unity confirm their availability status. The dispatcher may be notified on a smart phone, on a dashboard of the dispatch system 104, or other computing device. The notification prompts the dispatcher to confirm, over the LMR, the availability of the agency unit.

At block 310, the resource management system 102 executes error correction procedures when it is determined that the agency units are incorrectly identified as at least one of assigned and available. In some embodiments, the error correction procedures include updating the CAD database 110 with the correct availability status of the agency units. The dispatcher is notified of the correction via the dispatch system 104. In some embodiments, the error correction procedures include notifying the dispatcher of the error via the dispatch system 104. The dispatcher is further prompted to correct the availability status of the agency units.

In some embodiments, at block 308 resource management system 102 further analyzes the content of the mobile radio communication in real-time to confirm that the dispatched agency unit matches the assigned agency unit. Consider the following example. In this example, the dispatcher mistakenly assigned Unit 1A111 as the dispatched agency unit in the CAD database 110. However, the dispatcher actually communicated with Unit 1A101. Accordingly, Unit 1A101 is going to proceed to an assigned location for the active incident and the assigned Unit 1A111 will not even realize that they are assigned.

At block 304, the resource management system 102 retrieves, from the CAD database 110, a description of the ongoing incident: US.U;1A111.US;En.DST; 123 Main Street. This description indicates that the status of Unit 1A111 has been updated to En (enroute) with the destination 123 Main Street.

At block 308, the resource management system 102 uses a language model or other machine learning model to analyze the communication, which includes the phrase “Jim is again on a domestic incident” from the dispatcher. The description of the ongoing incident assigned to the agency unit, Unit 1A111, including the address, incident type, required capacity, and the like, is compared with the content of the radio communication. As noted above, the radio communication includes communication between the dispatcher and the agency units. The radio communication may also include communication between different ones of the agency units.

Continuing the current example, from the CAD database 110, the resource management system 102 determines that Jim from Unit 1A101 has not dealt with any domestic incidents. However, the resource management system 102 identifies Jim from Unit 1A111 who has dealt with 15 domestic incidents.

In some embodiments, at block 310, the resource management system 102 automatically removes the assigned agency unit from the public safety incident and re-assigns the active incident to one of the unassigned agency units as part of the error correction procedures. Thus, in this example, Unit 1A101 would be removed and the active incident would be re-assigned to Unit 1A111. The resource management system 102 can inform the agency units of the change outside of the radio communication. Alternatively, the resource management system 102 can instruct the dispatcher to update the agency units.

In some embodiments, at block 310, the resource management system 102 presents instructions on the dashboard of the dispatcher system 104 to instruct the dispatcher with steps to implement the error correction procedures. For example, a message can be presented to the dispatcher explaining the ambiguity on the dashboard of the dispatch system 104. The message identifies the probable misunderstanding and offers solutions that resolve the problem. An optimal one of the solutions may be highlighted. For example, a first set of options is presented in Table 1 below.

TABLE 1

| Option | Action |
|---|---|
| 1* | Change the status of Unit 1A111 to FREE, set the status |
| | of Unit 1A101 to ENROUTE to 123 Main Street. |
| | (Preferred for time savings) |
| 2 | Talk to 1A101 to cancel the assignment, talk to 1A111 |
| | and assign them. |

Table 1 illustrates an example in which the resource management system 102 has determined that since Unit 1A101 is already enroute to the active incident, it would be preferable to simply change the assignment of agency units in the CAD database 110. Thus, Unit 1A111 is released from the active incident and Unit 1A101 is assigned to the active incident.

TABLE 2

| Option | Action |
|---|---|
| 1 | Change the status of Unit 1A111 to FREE, set the status |
| | of Unit 1A101 to ENROUTE to 123 Main Street. |
| 2* | Talk to 1A101 to cancel the assignment, talk to 1A111 and |
| | assign them. (Preferred for unit equipment provisions) |

In contrast to Table 1, Table 2 illustrates an example in which the resource management system 102 has determined that since Unit 1A111 has special equipment that is desirable for the active incident, it would be preferable to make sure that Unit 1A111 is sent to the active incident, even if it takes longer for Unit 1A111 to arrive. Thus, the dispatcher is instructed to communicate with Unit 1A111 to instruct them to proceed to the active incident and to communicate with Unit 1A101 to instruct them to stand down from the active incident.

In another example, when the resource management system 102 analyzes the communication with the dispatcher, the communication with Unit 1A111 may suggest that the agency unit is not responding to the active incident. For example, the communication may include the phrase “I am going on break in 15 minutes”. Conversely, the communication with Unit 1A101 may suggest that the agency unit is responding to the active incident. For example, the communication may include the phrase “Estimated arrival time at 123 Main Street is 20 minutes”.

In some embodiments, at block 308 the resource management system 102 continues to monitor the dispatched agency unit to validate that the agency unit is progressing toward to the assigned public safety incident when the dispatched agency unit matches the assigned agency unit. Consider the following example. Agency unit 1A200 is dispatched to the location of the active incident. After the agency unit has been dispatched, the agency unit is detected commenting “Another domestic violence incident. It sure has been busy today.” The resource management system 102 processes the consistency of the content of the speech with the assigned active incident and improves the confidence score that the agency unit is progressing toward the active incident.

In contrast, had the agency unit 1A200 been detected communicating with his daughter and promising that he will be home in 10 minutes, the resource management system 102 would process the ambiguity. If the ambiguity is sufficient to drop the confidence level that the agency unit is proceeding to the active incident below a predefined threshold, then the resource management system 102 determines that the dispatched agency unit has diverted from the assigned active incident. The resource management system 102 executes error correction procedures. The error correction procedures may provide instruction to the dispatcher to confirm that the agency unit is proceeding to the assigned active incident. If not, the resource management system 102 may re-assign the active incident to another, inactive agency unit as described above.

In some embodiments, the resource management system 102 further monitors a location of the agency units in real-time. The location of the agency units is used to validate the analysed content from the mobile radio communication. The location of the agency units can be determined from a plurality of different sources. For example, the location of the agency unit may be determined from the location of the agency unit's radio, smart phone or other communication device, and vehicle, which is shared with the resource management system 102 by the public safety communication system 106. The location of these devices may be identified using location systems such as a Global Navigation Satellite System (GNSS). The location of the agency unit may also be determined based on the analysis of the communication between the agency unit and the dispatcher or other agency units. For example, the agency unit may advise the dispatcher that they are approaching a specific intersection. The resource management system 102 may also use information from the external surveillance systems 140 to locate the agency unit. For example, resource management system 102 analyses data from the surveillance devices 142 to refine the location of the agency unit. That is, one or more video feeds from the CCTV, data from the door/building access devices, and data from the halo sensors can be processed by the resource management system 102. Thus, for example, although the GNSS may be able to locate the agency unit to a particular building, data from the surveillance devices 142 can help refine the location information to determine a floor and even the specific unit or apartment on the floor.

If the resource management system 102 determines that the location of the agency unit is moving away from the assigned active incident, then the resource management system 102 determines that the dispatched agency unit has diverted from the assigned active incident. The resource management system 102 executes error correction procedures. The error correction procedures may provide instruction to the dispatcher to confirm that the agency unit understands that it is to proceed to the assigned active incident. If so, the management system 102 may notify the agency unit that they are travelling in the wrong direction and provide corrective action. Alternatively, or additionally, the resource management system 102 may notify the dispatcher that the agency unit is travelling in the wrong direction and provide instruction for corrective action. Otherwise, the resource management system 102 may re-assign the active incident to another, inactive agency unit as described above.

In some embodiments, the resource management system 102 analyses the public safety incidents to identify incidents proximal to each other to which multiple agency units have been assigned. The resource management system communicates to each of the multiple agency units, information about the incidents proximal to the public safety incident to which they have been assigned.

Consider, for example, two different active incidents at the same building at the same time, but in different apartments. The first active incident is an emergency medical services call. The second active incident is a law enforcement call about domestic violence with injuries. Typically, different agencies will have different incidents generated for law enforcement, emergency medical services, and firefighters. Accordingly, for the first active incident it is likely that an emergency medical services agency unit will be dispatched. For the second active incident, it is possible that both a law enforcement agency unit and an emergency medical services agency unit will be dispatched. This could lead to ambiguity for the two different emergency medical services agency units. Accordingly, the resource management system 102 informs each of the agency units of the others presence to avoid possible confusion. As described above, the resource management system 102 can communicate the information directly to the agency units or the information can be presented to the dispatcher for relaying to the agency units.

In some embodiments, the resource management system 102 may further sequence arrival of the multiple agency units to the proximal incidents. Continuing the previous example, both law enforcement agency units and emergency medical services agency units are dispatched. Accordingly, the resource management system 102 informs the emergency medical services agency units to stage (wait) close to the location of the active incident, until it has been cleared by the law enforcement agency units. As described above, the resource management system 102 can communicate the information directly to the agency units or the information can be presented to the dispatcher for relaying to the agency units. Ensuring that the active incident has been cleared prior to the arrival of the emergency medical services agency units reduces the risk of the emergency medical services agency units arriving when a possible suspect is armed and still at the active incident location.

In support of the above, resource management system 102 detects and processes ambiguities in the content of the communications. The resource management system 102 may also detect and process ambiguities in the location of the agency units. For example, there may be a lexical ambiguity in which a single word may have multiple meanings. The phrase “Where is officer Alex and team. They need to manage the traffic on Main Street.” In this phrase, the word “they” is ambiguous as it refers to multiple unclear individuals. The resource management system 102 would identify which Alex is referenced and then identify the members of Alex's team, including which members are assigned to the incident and present before confirming the assignments of the agency units.

As another example, there may be syntactic or structural ambiguity in which a sentence can be parsed into multiple meanings. A dispatcher may request “Paramedic A, please assist paramedic B with a defibrillator”. In this phrase, the ambiguity is whether Paramedic A should search for a paramedic holding a defibrillator or whether Paramedic A should bring a defibrillator as Paramedic B is missing one. The resource management system 102 detects the ambiguity and prompts the dispatcher to clarify and confirm the task.

As another example, there may be an ambiguity when the action of response of an agency unit conflicts with the content of the corresponding communication. A dispatcher may assign Officer A to stand guard at a south entrance, “Officer A please stand guard at south entrance”. Officer A response “Got it, I'm on my way”. Analysis of video surveillance shows Officer A getting interrupted on the way to the south entrance and being diverted to assist a victim in critical condition. The resource management system 102 detects the ambiguity and performs corrective action. The corrective action includes requesting confirmation from Officer A and re-assigns the task of guarding the south entrance to another officer.

As another example, there may be an ambiguity when the location of an agency unit conflicts with the content of the corresponding communication. A dispatcher may assign Unit 112 to incident A, “Unit 112, please enroute to 456, street 666, burglary alarm”. Unit 112 responds “Unit 112 responding”. However, the resource management system 102 determines from the global positioning system (GPS) of Unit 112, that it is moving in the wrong direction. As previously described, the resource management system 102 requests confirmation from Unit 112 and takes corrective action by re-routing Unit 112.

As another example, there may be an ambiguity between the context of the active incident and the content of the communication. An agency unit may communicate “I am going to escort Person C.” However, the agency unit is assigned to Event 1 and Person C is not within the scope of Event 1. Rather, Person C could be a person of interest for another event. The resource management system 102 would request confirmation from the Agency Unit and re-assign escorting Person C or Event 1, as required.

As another example, there may be an ambiguity between a role of the agency unit and the content of the communication. A non-supervisor may assign a task to another agency unit. The resource management system 102 detects that a person in a non-supervisory role assigned a task that may create conflicts. The resource management system 102 may request confirmation from supervisor, dispatcher, or both before performing confirming the assignment. Alternatively, a user with a specific role may be assigned to an active incident that is beyond their competency. A paramedic may take on an activity of performing traffic management. Paramedic A communicates to the dispatcher “I am going to help with to divert the traffic on street 123.” The resource management system 102 detects the ambiguity of a paramedic trying to manage traffic. The resource management system 102 will alert the dispatcher and/or to assign an agency unit more suited to the activity.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to three or more subsequently defined options such as “one of A, B, and C” should be construed to mean an existence of any one of the options in the list alone (e.g., A alone, B alone, or C alone) or any combination of the three or more of the options in the list (e.g., A and B and C together, A and B together, A and C together, or B and C together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

What is claimed is:

1. A method comprising:
retrieving a first dataset comprising information identifying active public safety incidents;
retrieving a second dataset comprising information identifying agency units assigned by dispatchers to the active public safety incidents;
monitoring mobile radio communication between the dispatchers and agency units dispatched by the dispatchers;
analysing, using a machine learning model, content of the mobile radio communication in real-time to confirm which of the agency units are available and which are assigned to the active public safety incidents; and
executing error correction procedures when it is determined that the agency units are incorrectly identified as at least one of assigned and available.

2. The method of claim 1, further comprising:
analysing content of the mobile radio communication in real-time using the machine learning model to confirm that the dispatched agency unit matches the assigned agency unit; and
executing error correction procedures when the dispatched agency unit does not match the assigned agency unit.

3. The method of claim 2, further comprising:
continuing to monitor the dispatched agency unit to validate that the agency unit is progressing toward to the assigned public safety incident when the dispatched agency unit matches the assigned agency unit; and
executing error correction procedures when it is determined that the dispatched agency unit diverts from the assigned public safety incident.

4. The method of claim 1, further comprising automatically:
removing the assigned agency unit from the public safety incident, and
re-assigning the public safety incident to one of the available agency units as part of the error correction procedures.

5. The method of claim 1, further comprising presenting instructions on a graphical user interface of the dispatcher to instruct the dispatcher with steps to implement the error correction procedures.

6. The method of claim 1, further comprising analysing at least one of a voice signature, background noise, and speech structure in the mobile radio communication to determine an identity of the dispatched agency unit.

7. The method of claim 1, further comprising:
monitoring a location of the agency units in real-time; and
using the location of the agency units to validate the analysed content from the mobile radio communication.

8. The method of claim 3, further comprising monitoring inter-unit mobile radio communication between different ones of the agency units and analysing content of the inter-unit mobile radio communication to validate that the agency unit is progressing towards the assigned public safety incident.

9. The method of claim 1, wherein the error correction procedures further comprise transmitting an alert to the dispatcher and the dispatched agency unit outside of the mobile radio communication to validate the determination that the agency units are incorrectly identified as at least one of assigned and available.

10. The method of claim 1, further comprising:
analysing the public safety incidents to identify incidents proximal to each other to which multiple agency units have been assigned; and
communicating to each of the multiple agency units, information about the incidents proximal to the public safety incident to which they have been assigned.

11. The method of claim 10, further comprising sequencing arrival of the multiple agency units to the proximal incidents.

12. A resource management system comprising a processor and a non-transitory memory having instructions stored thereon, the instructions, when executed by the processor, cause the processor to:
retrieve a first dataset comprising information identifying active public safety incidents;
retrieve a second dataset comprising information identifying agency units assigned by dispatchers to the active public safety incidents;
monitor mobile radio communication between the dispatchers and agency units dispatched by the dispatchers;
analyse content of the mobile radio communication in real-time to confirm which of the agency units are available and which are assigned to the active public safety incidents; and
execute error correction procedures when it is determined that the agency units are incorrectly identified as at least one of assigned and available.

13. The resource management system of claim 12, further comprising instructions to:
analyse content of the mobile radio communication in real-time to confirm that the dispatched agency unit matches the assigned agency unit; and
execute error correction procedures when the dispatched agency unit does not match the assigned agency unit.

14. The resource management system of claim 13, further comprising instructions to:
continue to monitor the dispatched agency unit to validate that the agency unit is progressing toward to the assigned public safety incident when the dispatched agency unit matches the assigned agency unit; and
execute error correction procedures when it is determined that the dispatched agency unit diverts from the assigned public safety incident.

15. The resource management system of claim 12, further comprising instruction to automatically:
remove the assigned agency unit from the public safety incident, and
re-assign the public safety incident to one of the unassigned agency units as part of the error correction procedures.

16. The resource management system of claim 12, further comprising instructions to present instructions on a graphical user interface of a dispatch system to instruct the dispatcher with steps to implement the error correction procedures.

17. The resource management system of claim 12, further comprising instructions to analyse at least one of a voice signature, background noise, and speech structure in the mobile radio communication to determine an identity of the dispatched agency unit.

18. The resource management system of claim 12, further comprising instructions to:
monitor a location of the agency units in real-time; and
use the location of the agency units to validate the analysed content from the mobile radio communication.

19. The resource management system of claim 14, further comprising instructions to monitor inter-unit mobile radio communication between different ones of the agency units and analyse content of the inter-unit mobile radio communication to validate that the agency unit is progressing towards the assigned public safety incident.

20. The resource management system of claim 12, wherein the error correction procedures further comprise transmitting an alert to the dispatcher and the dispatched agency unit outside of the mobile radio communication to validate the determination that the agency units are incorrectly identified as at least one of assigned and available.

21. The resource management system of claim 12, further comprising instructions to:
analyse the public safety incidents to identify incidents proximal to each other to which multiple agency units have been assigned; and
communicate to each of the multiple agency units, information about the incidents proximal to the public safety incident to which they have been assigned.

22. The resource management system of claim 21, further comprising instructions to sequence arrival of the multiple agency units to the proximal incidents.
